(19) United States
(12) Patent Application Publication
(10) Pub. No.: US 2022/0178189 A1
(43) Pub. Date: Jun. 9, 2022

(54) DOOR STOP

(71) Applicant: Nathan L. Argetsinger, Flagstaff, AZ (US)

(72) Inventor: Nathan L. Argetsinger, Flagstaff, AZ (US)

(21) Appl. No.: 17/535,994

(22) Filed: Nov. 27, 2021

Related U.S. Application Data
(60) Provisional application No. 63/205,333, filed on Dec. 4, 2020.

(51) Int. Cl. E05F 5/04

(52) U.S. Cl. CPC E05F 5/04

(57) ABSTRACT

An improved door stop adapted to be removably attached to an outer edge of a pivoting door, preferably the top edge, and is adapted to contact a door frame attached thereto and prevent the door from pivoting to a fully closed position and engaging the door frame and locking a person, or even an animal, within a room.

### CROSS-REFERENCE TO RELATED APPLICATION

There present application is related to and claims priority from prior provisional application serial number 63/205,333, filed Dec. 4, 2020 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to door stops used on doors pivotally attached to a door frame.

### 2. Description of the Related Art

Prior art door stops for pivoting doors have commonly been formed as elongated rods attached either to a door adapted to engage a wall or door frame member, or attached to a wall adapted to engage the door and stop its pivotal movement outwardly from its door frame and thereby prevent damage to an adjacent wall. The problem with the prior art door stops is that they do not prevent the door from pivoting into a closed position wherein the door engages and can be locked to the door frame in a closed position. As such a person, especially a child, can become locked within a room.

Accordingly, the present invention overcomes the disadvantages associated with the prior art, by providing an improved door stop that is adapted to be removably attached to an outer edge of a door, preferably the top edge, and adapted to contact a respective door frame and prevent the door from pivoting to a fully closed position and engaging the door frame and locking a person, or even an animal, within a room.

### BRIEF SUMMARY OF THE INVENTION

In view of the foregoing disadvantages inherent in the known types of door stops within the prior art, the present invention provides an improved door stop for pivoting doors. As such, the general purpose of the present invention, which will be described subsequently in greater detail, is to provide an improved door stop adapted to be removably attached to an outer edge of a pivoting door, preferably the top edge, and is adapted to contact a door frame attached thereto and prevent the door from pivoting to a fully closed position and engaging the door frame and locking a person, or even an animal, within a room with all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1a shows a perspective view of the improved door stop according to the preferred embodiment of the present invention.

FIG. 1b shows a front view of the improved door stop according to the preferred embodiment of the present invention of FIG. 1a.

FIG. 2a shows a back perspective view of the improved door stop in-use upon a pivoting door according to the preferred embodiment of the present invention of FIG. 1a.

FIG. 2b shows a front perspective front view of the improved door stop in-use upon a pivoting door according to the preferred embodiment of the present invention of FIG. 1a.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

As described above, the instant invention comprises an improved door stop 100 adapted to be removably attached to an outer edge of a pivoting door 200, preferably the top edge, and is adapted to contact a door frame 210 attached thereto and prevent the door from pivoting to a fully closed position and engaging the door frame and locking a person, or even an animal, on the other side.

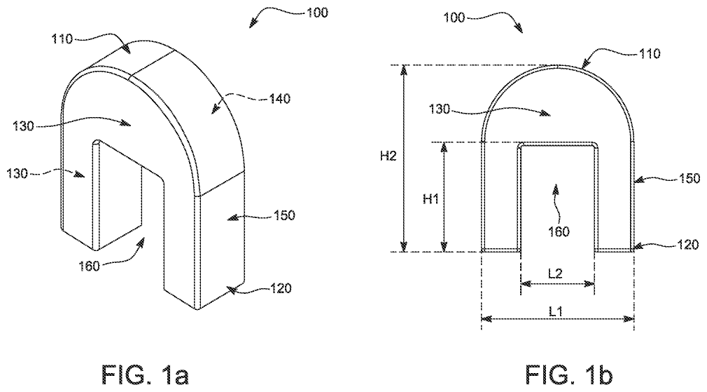

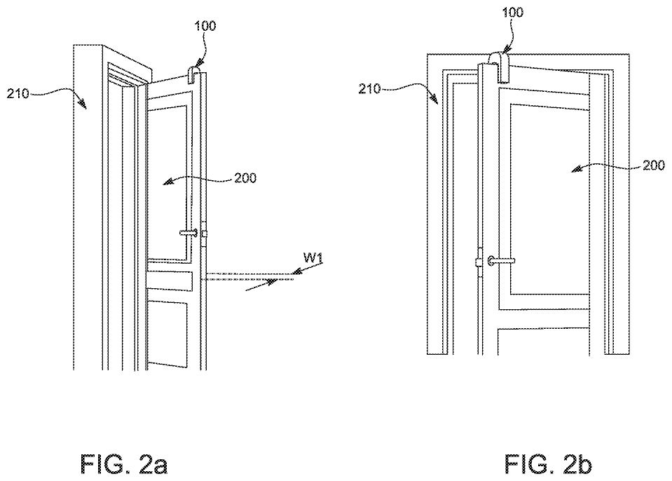

Turning now descriptively to drawing, referring to FIGS. 1a-2b, the present invention discloses an improved door stop for use upon a pivoting door 200 including an outer edge and at least one side edge adapted to be pivotally connected to a door frame 210, wherein the pivoting door has a width (W1). The improved door stop 100 comprises a main body comprising a top portion 110, a bottom portion 120 formed having a length (L1), a front surface 130, a back surface 140, two side portions 150 spaced from each other and extending between the bottom portion and the top portion, and wherein the two side portions are formed having a height (H1), a cut-out portion 160 formed in between the two side portions and extends from the bottom portion towards the top portion and formed having a length (L2), wherein the main body is formed having a height (H2), and wherein the improved door stop 100 is adapted to be removably attached to the outer edge of the pivoting door via the cut-out portion, and is adapted to contact the door frame used in conjunction with the pivoting door via the top portion or either of the two side portions and prevent the door from pivoting to a fully closed position, engaging the door frame, and from becoming locked in the fully closed position.

In the preferred embodiment the top portion 110 is formed having an arc-shape, the cut-out portion is formed having a rectangular shape and has a height (H1) substantially equal to the two side portions. Furthermore, the main body may be formed from a silicone material, which would not dent or scratch the door frame, and would aid in its flexibility when applying to the edge of the door. However, the main body may be formed from other materials, such as plastic or a foam material.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. An improved door stop for pivoting doors, comprising:
a main body comprising;
a top portion;
a bottom portion;
wherein said bottom portion is formed having a length;
a front surface;
a back surface;
two side portions;
wherein said two side portions are spaced from each other and extend between said bottom portion and said top portion;
wherein said two side portions are formed having a height;
a cut-out portion;
wherein said cut-out portion is formed in between said two side portions and extends from said bottom portion towards said top portion; and
wherein said cut-out portion is formed having a length;
wherein said main body is formed having a height; and
wherein said improved door stop is adapted to be removably attached to an outer edge of a pivoting door via said cut-out portion, and is adapted to contact a door frame used in conjunction with said pivoting door via said top portion or either of said two side portions and prevent said door from pivoting to a fully closed position, engaging said door frame, and from becoming locked in said fully closed position.

2. The improved door stop of claim 1, wherein said top portion is formed having an arc-shape.

3. The improved door stop of claim 1, wherein said cut-out portion is formed having a rectangular shape;

4. The improved door stop of claim 1, wherein said cut-out portion is formed having a height substantially equal to said two side portions.

5. The improved door stop of claim 1, wherein said main body is formed from a silicone material adapted to increase the flexibility of said main body and increase the ease of use when applying to said outer edge of said door.

6. A combination of a pivoting door and an improved door stop, comprising:
a pivoting door including:
an outer edge; and
at least one side edge;
wherein said at least one side edge is adapted to be pivotally connected to a door frame;
wherein said pivoting door has a width;
an improved door stop comprising:
a main body comprising;
a top portion;
a bottom portion;
wherein said bottom portion is formed having a length;
a front surface;
a back surface;
two side portions;
wherein said two side portions are spaced from each other and extend between said bottom portion and said top portion;
wherein said two side portions are formed having a height;
a cut-out portion;
wherein said cut-out portion is formed in between said two side portions and extends from said bottom portion towards said top portion; and
wherein said cut-out portion is formed having a length;
wherein said main body is formed having a height; and
wherein said improved door stop is adapted to be removably attached to said outer edge of said pivoting door via said cut-out portion, and is adapted to contact a door frame used in conjunction with said pivoting door via said top portion or either of said two side portions and prevent said door from pivoting to a fully closed position, engaging said door frame, and from becoming locked in said fully closed position.

7. The improved door stop of claim 6, wherein said top portion is formed having an arc-shape.

8. The improved door stop of claim 6, wherein said cut-out portion is formed having a rectangular shape;

9. The improved door stop of claim 6, wherein said cut-out portion is formed having a height substantially equal to said two side portions.

10. The improved door stop of claim 6, wherein said main body is formed from a silicone material adapted to increase the flexibility of said main body and increase the ease of use when applying to said outer edge of said door.
